(19) United States
(12) Patent Application Publication
(10) Pub. No.: US 2009/0195811 A1
(43) Pub. Date: Aug. 6, 2009

(54) METHOD FOR PRINTING TEXT-ONLY CONTENT OF PDF DOCUMENTS

(75) Inventor: James Jung-Hyun Lee, Los Angeles, CA (US)

Correspondence Address: YING CHEN;Chen Yoshimura LLP, 255 S. GRAND AVE., # 215, LOS ANGELES, CA, 90012, US

(73) Assignee: KONICA MINOLTA SYSTEMS LABORATORY, INC., Huntington Beach, CA (US)

(21) Appl. No.: 12/025,735

(22) Filed: Feb. 4, 2008

(51) Int. Cl. G06F 3/12

(52) U.S. Cl. 358/1.15

(57) ABSTRACT

A method for printing only text objects within a PDF document is described. PDF data is transmitted from a host computer to a printer, along with job information that specifies a text-only mode. If printer controller detects that the text-only mode is specified, it interprets only the text objects within the PDF data. As a result, only text objects are printed on the recording medium, and the graphics and image objects are not printed. The interpretation step preserves position, font, size, and style (e.g. bold, italic, underline) of the text objects. Representation may be generated and printed on the recording medium to indicate the presence of graphics or image objects in the original PDF document.

### BACKGROUND OF THE INVENTION

1. Field of the Invention

This invention relates to methods of printing PDF (Portable Document Format) or other documents, and in particular, it relates to methods of printing only the text content of PDF or other documents.

2. Description of Related Art

Some PDF files contain very complex layouts, heavy bitmaps, transparencies, and other graphics-intensive objects along with text. These PDF files may take a very long time to print. Sometimes the user may be primarily interested in just the text content of a document. Thus, it would be advantageous to allow the user to print just the text of a document for expediency reasons.

### SUMMARY

Embodiments of the present invention provide a method for printing only text objects within a PDF document.

An object of the present invention is to provide a PDF printing method that allows for printing of the text of a PDF document at a much faster speed.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and/or other objects, as embodied and broadly described, the present invention provides a method implemented on a data processing system including a printer and a host computer, including, on the printer: (a) receiving PDF data for a print job and information describing the print job; (b) determining a printing mode of the print job based on the information describing the print job; (c) when the printing mode is a text-only printing mode, interpreting only text objects contained in the PDF data to generated interpreted data; (d) processing the interpreted data to form image data; and (e) printing the image data on a recording medium, whereby the printed image contains text content without graphics or image content.

In another aspect, the present invention provides a computer program for controlling a printer to perform the above method.

In yet another aspect, the present invention provides a printer which includes: a control and processing section; a print engine connected to the control and processing section for forming an image on a recording medium; and an I/O section connected to the control and processing section for receiving data from an external device, wherein the control and processing section is programmed to receive Portable Document Format (PDF) data for a print job and to receive information describing the print job, to determine a printing mode of the print job based on the information describing the print job, and when the printing mode is a text-only printing mode, to interpret only text objects contained in the PDF data to generated interpreted data, and to processing the interpreted data to form image data, and wherein the print engine prints the image data on the recording medium, whereby the printed image contains text content without graphics or image content.

More generally, the present invention provides a printing method implemented in a data processing system including a host computer and a printer connected to each other, the method including: (a) the host computer sending a print job to the printer, the print job including a document file and an instruction to print the document file, wherein the document file includes a plurality of objects and information regarding arrangements of the objects, the objects including text objects and non-text objects; (b) the printer determining if the instruction indicates a draft-printing mode; (c) the printer converting the document file into print data, wherein if the instruction indicates a draft-printing mode, the printer converts all the text objects and a subset but not all of the non-text objects in the document file into print data; and (d) the printer printing an image based on the print data.

It is to be understood that both the foregoing general description and the following detailed description are exemplary and explanatory and are intended to provide further explanation of the invention as claimed.

### BRIEF DESCRIPTION OF THE DRAWINGS

FIG. 1 shows an example of an original PDF document and a document printed using a text-only PDF printing method according to an embodiment of the present invention.

FIG. 2 shows an example of an original PDF document and a document printed using a text-only PDF printing method according to another embodiment of the present invention.

FIG. 3 illustrates a method performed by a printer controller for text-only PDF direct printing according to an embodiment of the present invention.

FIG. 4 illustrates a method performed by a host computer for submitting a PDF document to a printer for text-only PDF direct printing according to an embodiment of the present invention.

FIG. 5 illustrates a system including a host computer and a printer in which the text-only PDF printing method according to embodiments of the present invention can be implemented.

### DETAILED DESCRIPTION OF PREFERRED EMBODIMENTS

The methods described herein can be implemented in a data processing system which includes a host computer and a printer connected to the host computer. A typical structure of such a data processing system is shown in FIG. 5. The host computer 110 includes a processor 111 and one or more memories 112 for storing programs and data (such as PDF files). The processor 111 executes the software programs to carry out various steps of the text-only PDF printing methods described in this disclosure. The printer 120 typically includes a controller 121, an image processing section 122, a print engine 123, and an input/output (I/O) section 124. The controller 121 may include a central processing unit (CPU), a random access memory (RAM), a read only memory (ROM) for storing programs, and other memories as appropriate. The controller performs various processing functions, including interpretation of PDF data or PDL (Page Description Language) data, rendering raster images, etc. The printer controller 121 executes software programs to carry out various steps of the text-only PDF printing methods described in this disclosure. The image processing section 122 carries out various image processing on the raster image data under the control of the controller 121, and sends the processed image data to the print engine 123. The print engine 123 forms an image on a recording medium based on the image data from the image processing section 122. The I/O section 124 performs data transfer with the host computer 110.

Embodiments of the present invention provide a method for printing only text objects within a PDF document. In a PDF file, data objects of different types, such as text, graphics (e.g. vector data), and image (e.g. bitmap or JPEG data) are identified by tags. These tags are used to differentiate different types of objects and to process only the text objects. Text-only PDF printing will be significantly faster than printing an entire PDF document for a document that contains large amounts of graphics or image data. If the user is only concerned about the text content and is not concerned about graphics, layout, background, watermarks, etc., then text-only PDF printing will provide optimal performance for such a situation.

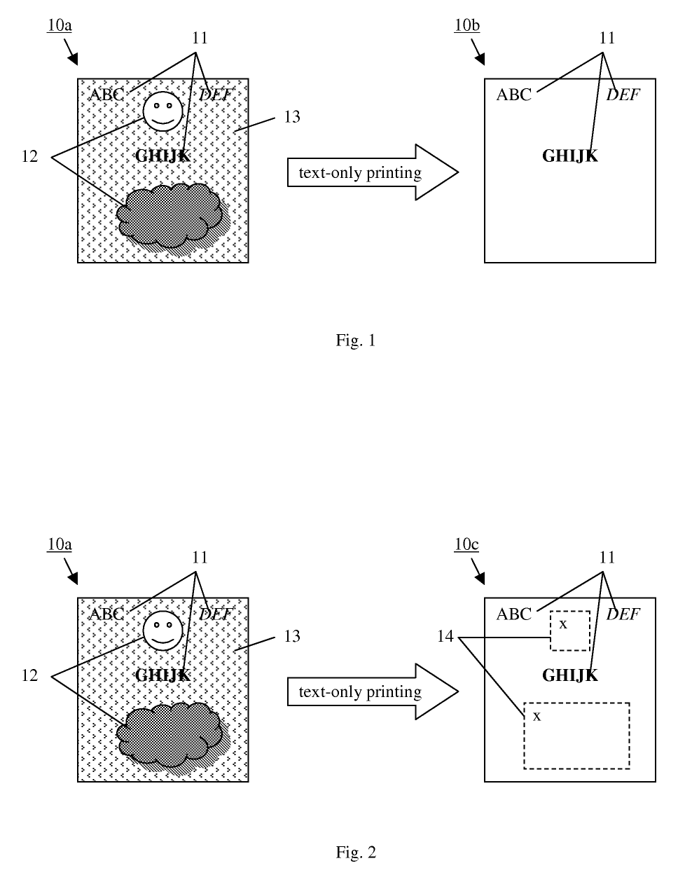

FIG. 1 illustrates a result of text-only PDF printing according to one embodiment of the present invention. FIG. 1 shows an original document 10a which includes, for example, text contents 11, graphics and/or image contents 12, and background graphics 13. After being processed using the text-only PDF printing method, the printed document 10b includes only the text contents 11. The graphics and/or image contents 12 and background graphics 13 are not printed.

In a preferred embodiment, the text-only PDF printing method is implemented using a PDF direct printing technology. PDF direct printing is a technology by which the host computer transfers PDF files directly to the printer without using a printer driver to interpret the PDF data into data in a printer language format, commonly referred to as PDL (Page Description Language), such as PostScript or PCL (Printer Command Language). The printer controller processes the received PDF, including interpreting the PDF data into PDL data.

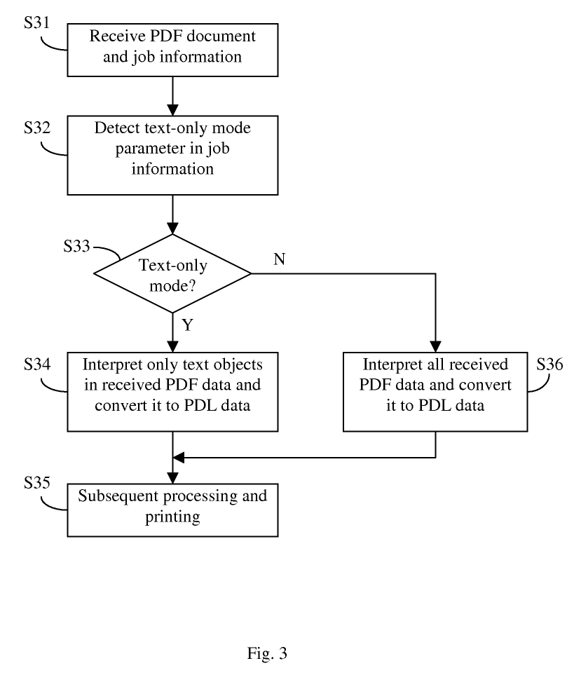

FIG. 3 illustrates a method carried out by the printer controller under the first embodiment. The printer controller receives, from the host computer, a PDF document for a print job along with information describing the print job (“job information”, also referred to as a “job ticket” in some instances) (step S31). The job information may be specified in various standard formats, such as Printer Job Language (PJL), Job Definition Format (JDF), etc., or non-standard formats. One parameter contained in the job information is a parameter or tag that identifies the print job as a text-only PDF print job (referred to as the text-only mode parameter here). For example, this can be accomplished through a customized PJL or JDF parameter. In the PJL examine, the parameter may be:

@PJL TEXT₁₃ ONLY=TRUE

In the JDF example, the parameter may be:

<JDF>
<InterpretingParams TextOnly=”true”/>
</JDF>

The printer controller detects the text-only mode parameter in the job information (step S32). If the text-only mode parameter indicates that the print job is not submitted for text-only printing (“N” in step S33), the printer controller carries out the normal process of PDF direct printing, including interpreting the PDF data (all of the received PDF data, including both text and non-text objects) and converting it to PDL data, such as Postscript data (step S36). The PDL data is further processed according to a normal printing process, such as rendering a raster image, processing the raster image, and printing the image on a recording medium (step S35). Note that in steps S32 and S33, if the printer controller detects that the job information does not contain a text-only mode parameter, the printer controller will determine that the print job is not submitted for text-only printing.

On the other hand, if the printer controller detects a text-only mode parameter indicating that the print job is submitted for text-only printing (“Y” in step S33), the printer controller interprets only the text objects in the received PDF data and converts that portion of the PDF data to PDL data (step S34). The printer controller then performs subsequent processing of the PDL data, such as rendering a raster image from the PDL data, and prints the image in the same way as in a normal printing process (step S35). Preferably, when interpreting the text objects in the PDF data (during step S34), certain attributes associated with the text objects, such as position, font, size, and style (e.g. bold, italic, underline) of the text, are preserved in the interpretation. As a result, on the printed document, the text appears at the positions specified by the original PDF data and have the font, size and style specified by the original PDF data. In one embodiment, special text effects such as clipping, warping, and shaping are ignored during the interpretation. In another embodiment, such special text effects are preserved, so that the printed text will carry such special effects.

In one embodiment, the graphics and image objects in the PDF data are simply ignored during the interpretation step S34. Preferably, the positions of the text objects are preserved; in other words, the text objects will appear on the printed pages at positions where they would appear when all objects are fully printed. Because PDF data specify the position of each object, this can be accomplished if the position data for the text objects in the PDF file are used without any change during text-only printing. Of course, if desired, it is also possible to move the positions of the text objects so that no large empty spaces are left on the printed pages. In another embodiment, the printer controller obtains location and size (if available) information for the graphics and image objects within the PDF data, and generates a representation that indicates the presence of each graphics or image object in the original PDF document. For example, a box (or border) may be drawn to indicate that an image is present at a certain approximate location in the original PDF data even though the content of the image is not printed. FIG. 3 illustrates a printed document 10c where representations 14 (as an example, boxes with an x inside them) are included in the printed document to indicate the presence of graphics or image objects in the original PDF document 10a. It is noted that in some cases the size of a graphics object is not known without rendering the graphics; in such a case, a box of a default size may be used to indicate the presence of the graphics in the original PDF document.

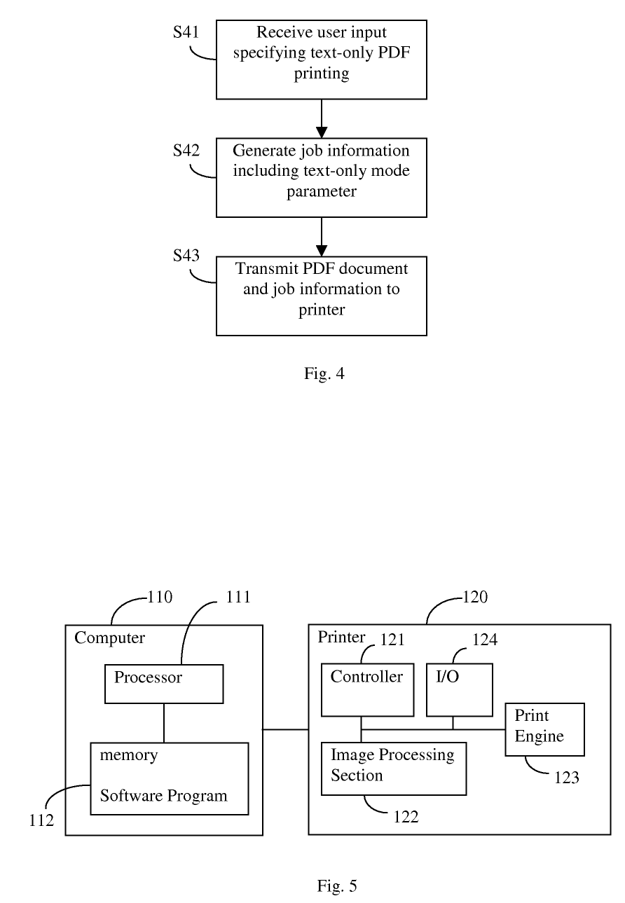

Because the first embodiment of the present invention use a PDF direct printing method, the software programs on the host computer 110 do not need substantial modification to carry out text-only PDF printing. The software program only needs to be modified to insert a text-only mode parameter described above in the job information before submitting the print job to the printer. For example, there exist print management software programs that can submit PDF documents to a printer for direct printing. A print management program has a user interface that allows the user to specify various conditions for the print job, such as paper requirements, finishing requirements, etc. The user interface can be modified to additionally allow the user to specify the print job as a text-only print job. When the user specifies text-only printing, the print management application adds the text-only mode parameter to the job information before submitting it to the printer. As summarized in FIG. 4, the software program on the host computer receives a user input specifying text-only PDF printing (step S41), generates job information including the text-only mode parameter (step S42), and transmits the PDF document and the job information to the printer for printing (step S43).

In an alternative embodiment, the text-only PDF printing method is implemented without using the PDF direct printing technology. Under this approach, a printer driver program on the host computer interprets the PDF data in a PDF document and converts it to PDL data, and sends the PDL data to the printer for printing. If a text-only printing mode is specified (the user specifies the printing mode using the same methods described above), the printer driver program interprets only the text objects within the PDF document. If a text-only printing mode is not specified, the printer driver program interprets all data objects within the PDF document. Thus, steps S31 to S34 and S36 shown in FIG. 3 are performed by the printer driver program on the host computer, rather than the printer controller. After steps S34 and S36, the printer driver transmits the PDL data to the printer for further processing and printing.

The text-only PDF printing method described above have many advantages, particularly for a PDF document that contains large amounts of graphics or image data. A main advantage is the significant time saving the method can provide. For example, if an editor wants to print 50 graphics-intensive documents that take 5 minutes each to print, it will take a total of 250 minutes (4 hours 10 minutes) to print all 50 documents. If the editor is not concerned about nice graphics or detailed layouts but just wants the text content for proofreading purposes, the text-only mode will allow the editor to print just the text of the documents much faster. Instead of taking 5 minutes for each document, in text-only mode it may take only 15 seconds each, which brings the total time to print the 50 documents at 750 seconds or 12.5 minutes. Another advantage of the text-only printing method is that it saves resources such as toner or ink.

Although text-only printing of PDF documents is described above, the method can be applied to the printing of other types of documents, so long as the document contains both text and non-text (e.g. graphics and image) contents and information on arrangements of the various contents.

Further, although the method described above are text-only printing, i.e., only text contents are printed and none of the non-text content are printed, the method can be expanded to a print a “draft” version of the document, which contains all of the text content but only a subset of the non-text (graphics and image) content. The decision of which non-text content to omit will be based on the amount of computation or memory required for processing such contents, the available resources on the printer or host computer, etc. To implement this draft-printing method, steps S32 and S33 in FIG. 3 will be replaced by a step of detecting a draft-printing mode from the job information. Step 34 will be replaced by a step of interpreting all text objects and a subset of the non-text objects in the received data.

It will be apparent to those skilled in the art that various modification and variations can be made in the text-only PDF printing method and apparatus of the present invention without departing from the spirit or scope of the invention. Thus, it is intended that the present invention cover modifications and variations that come within the scope of the appended claims and their equivalents.

What is claimed is:

1. A method implemented on a data processing system including a printer and a host computer, comprising:
on the printer:
(a) receiving PDF data for a print job and information describing the print job;
(b) determining a printing mode of the print job based on the information describing the print job;
(c) when the printing mode is a text-only printing mode, interpreting only text objects contained in the PDF data to generated interpreted data;
(d) processing the interpreted data to form image data; and
(e) printing the image data on a recording medium, whereby the printed image contains text content without graphics or image content.

2. The method of claim 1, wherein the interpreting step (c) preserves position, font, size and style of the text objects as specified in the PDF data.

3. The method of claim 1, further comprising:
(f) interpreting all objects contained in the PDF data when the printing mode is not a text-only printing mode.

4. The method of claim 1, further comprising:
(g) generating a representation indicating a presence of graphics or image objects in the PDF data without interpreting the graphics or image objects.

5. The method of claim 1, further comprising:
on the host computer:
(h) receiving from a user an input signal requesting text-only printing; and
(i) transmitting to the printer the PDF data and the information describing the print job including a parameter indicating the text-only printing mode.

6. A computer program product comprising a computer usable medium having a computer readable code embodied therein for controlling a printer, the computer readable program code configured to cause the printer to execute a process for printing Portable Document Format (PDF) data, the process comprising the steps of:
(a) receiving PDF data for a print job and information describing the print job;
(b) determining a printing mode of the print job based on the information describing the print job;
(c) when the printing mode is a text-only printing mode, interpreting only text objects contained in the PDF data to generated interpreted data;
(d) processing the interpreted data to form image data; and
(e) printing the image data on a recording medium, whereby the printed image contains text content without graphics or image content.

7. The computer program product of claim 6, wherein the interpreting step (c) preserves position, font, size and style of the text objects as specified in the PDF data.

8. The computer program product of claim 6, wherein the process further comprises:
(f) interpreting all objects contained in the PDF data when the printing mode is not a text-only printing mode.

9. The computer program product of claim 6, wherein the process further comprises:
(g) generating a representation indicating a presence of graphics or image objects in the PDF data without interpreting the graphics or image objects.

10. A printer comprising:
a control and processing section;
a print engine connected to the control and processing section for forming an image on a recording medium; and
an I/O section connected to the control and processing section for receiving data from an external device,
wherein the control and processing section is programmed to receive Portable Document Format (PDF) data for a print job and to receive information describing the print job, to determine a printing mode of the print job based on the information describing the print job, and when the printing mode is a text-only printing mode, to interpret only text objects contained in the PDF data to generated interpreted data, and to processing the interpreted data to form image data, and
wherein the print engine prints the image data on the recording medium, whereby the printed image contains text content without graphics or image content.

11. The printer of claim 10, wherein control and processing section preserves position, font, size and style of the text objects as specified in the PDF data when interpreting the text objects.

12. The printer of claim 10, wherein control and processing section is further programmed to interpret all objects contained in the PDF data when the printing mode is not a text-only printing mode.

13. The printer of claim 10, wherein the control and processing section is further programmed to generate a representation indicating a presence of graphics or image objects in the PDF data without interpreting the graphics or image objects.

14. A printing method implemented in a data processing system including a host computer and a printer connected to each other, the method comprising:
(a) the host computer sending a print job to the printer, the print job including a document file and an instruction to print the document file, wherein the document file includes a plurality of objects and information regarding arrangements of the objects, the objects including text objects and non-text objects;
(b) the printer determining if the instruction indicates a draft-printing mode;
(c) the printer converting the document file into print data, wherein if the instruction indicates a draft-printing mode, the printer converts all the text objects and a subset but not all of the non-text objects in the document file into print data; and
(d) the printer printing an image based on the print data.

15. The printing method of claim 15, wherein the document file is a PDF file.

16. The printing method of claim 15, wherein the print data is generated in accordance with the information regarding the arrangements of the objects included in the document file.

17. The printing method of claim 15, wherein the non-text objects include graphic objects.

18. The printing method of claim 15, wherein the print data includes images indicating that non-text objects are omitted.
